(19) United States
(12) Patent Application Publication
(10) Pub. No.: US 2024/0410294 A1
(43) Pub. Date: Dec. 12, 2024

(54) METHOD FOR RECOGNIZING AN ANOMALY IN MEASURED OPERATING VALUES OF A TURBOMACHINE, AND ANALYSIS DEVICE AND MACHINE MONITORING DEVICE

(71) Applicant: MTU Aero Engines AG, Muenchen (DE)

(72) Inventors: Duilio Becchio, Munich (DE); Jürgen Mathes, Germering (DE); Stephan Staudacher, Tiefenbronn (DE); Christian Keller, Minden (DE); Matthias Weiss, Süßen (DE)

(21) Appl. No.: 18/704,150

(22) PCT Filed: Oct. 19, 2022
(86) PCT No.: PCT/DE2022/100769

§ 371 Date: Apr. 24, 2024

(30) Foreign Application Priority Data
Oct. 28, 2021 (DE) 10 2021 128 065.6

(51) Int. Cl. F01D 21/00

(52) U.S. Cl. CPC F01D 21/003; F05D 2260/80

(57) ABSTRACT

A method for recognizing an anomaly in measured operating values of a turbomachine, in particular an aircraft turbine, including repeatedly detecting measured operating values of particular operating parameters of a turbomachine uring an operating period of the turbomachine, using sensors of the turbomachine, ascertaining quasi-steady-state time intervals of the operating period, using an analysis device, generating quasi-steady-state operating data points for the quasi-steady-state time intervals, the quasi-steady-state operating data points including averaged measured operating values, ascertaining particular expected data points which include particular expected operating values of the particular operating parameters, ascertaining particular measured operating value residuals of the particular operating parameters, checking the measured operating value residuals of the particular quasi-steady-state operating data points for compliance with predetermined anomaly criteria with regard to predefined nominal values of the measured operating value residuals, and transferring an anomaly indicator, which includes a violated anomaly criterion of the anomaly criteria and a point in time of the violation, to a machine monitoring device.

The present invention relates to a method for recognizing an anomaly in measured operating values of a turbomachine, in particular an aircraft, an analysis, and a machine monitoring device.

### BACKGROUND

For monitoring a state of a turbomachine, it is common for sensors of the turbomachine to detect measured operating values of particular operating parameters of the turbomachine during an operating period. To be able to identify gradual wear of as well as damage to the turbomachine, it is necessary to observe the measured operating values. In this regard, at characteristic points in time during an operating period it is customary to record particular data points that include the particular measured operating values of the particular operating parameters at a certain point in time, and transfer them to an engine condition monitoring system. These data points detected in multiple flights are added to a time series, via which the engine condition monitoring may detect damage occurring in the turbomachine. The data points are typically detected during characteristic phases of a flight. A first data point is generally detected during the takeoff or climbing phase of a flight, in which the turbomachine is subjected to a high load. A second data point is generally detected when the turbomachine is in a steady state during the flight.

For recognizing damage, it is customary to fall back on all available data points of the different mission phases, whereas for the monitoring of long-term aging effects, in particular the data points recorded during the steady-state phases of the flights are used.

### SUMMARY OF THE INVENTION

By use of this procedure, generally only a few data points for each flight are available for the damage detection. Since the data points include measured operating values that are detected at a certain point in time, they may include noise. If at least some measured operating values of particular operating parameters deviate from a standard, it is thus not unambiguously apparent from a single measurement whether this deviation is to be attributed to noise or to an actual error. Thus, multiple data points from particular flights are typically necessary to allow reliable classification of a deviation.

In addition to this previous type of engine condition monitoring which is based on the extracted data points, it is possible to detect spontaneously occurring errors or deviations in the turbomachine even within a flight, using continuously recorded measured data. Use of all these data points of the continuous flight data is not efficient for ascertaining long-term damage.

In the publication by Simon, D. L. and Litt, J. S. (2011), A data filter for identifying steady-state operating points in engine flight data for condition monitoring applications, Journal of Engineering for Gas Turbines and Power, 133(7), a data filter for identifying steady-state operating points in engine flight data for condition monitoring applications is provided. The publication describes an algorithm that identifies and extracts steady-state engine operating points in continuous engine flight data recordings. The algorithm monitors a standard deviation of predetermined data that are provided by the engine, and identifies an operating state of the engine as steady-state when the standard deviation of the measured data falls below a predetermined limit. The measured data that are detected over a certain time period are averaged and combined to form a steady-state data point.

DE 697 24 555 T2 provides a diagnostic trend analysis for aircraft engines. In the method, it is provided that outlier points associated with computed separating parameters are eliminated.

U.S. Pat. No. 7,979,192 B2 provides a method and a system for trend monitoring of aircraft engines. In the method, it is provided to record outputs of engine condition sensors and analyze the results to examine performance trends for piston engines and to allow a prediction concerning the need for engine maintenance.

An object of the present invention is to allow incorporation of continuously recorded flight data into existing engine condition monitoring systems.

The present invention provides a method for recognizing an anomaly in measured operating values of a turbomachine, in particular an aircraft turbine, an analysis device, and a machine monitoring device. Advantageous embodiments with suitable refinements of the present invention are set forth herein; advantageous embodiments of each aspect of the present invention are to be regarded as advantageous embodiments of the respective other aspects of the present invention.

A first aspect of the present invention relates to a method for recognizing an anomaly in measured operating values of a turbomachine, in particular an aircraft turbine. An anomaly may encompass, for example, a deviation in the behavior of the turbomachine from an expected operating behavior. In the method, it is provided that sensors of the turbomachine repeatedly detect the measured operating values of particular operating parameters of a turbomachine during an operating period of the turbomachine. In other words, it is provided that the particular measured operating values of particular operating parameters, which may include a number of revolutions, an operating temperature, or other operating parameters, for example, are detected. The detection is carried out by the sensors of the turbomachine. The detection may take place periodically or continuously during the operating period of the turbomachine. An operating period may be defined, for example, as a time interval between an activation and a deactivation of the turbomachine, or a certain predefined time interval in which the turbomachine is in a certain operating state. The operating period of the turbomachine may also describe a time period of a flight.

The detected measured operating values of the particular operating parameters are evaluated according to a predetermined analysis method, using an analysis device, in order to ascertain quasi-steady-state time intervals of the operating period that meet a predetermined quasi-steady-state criterion. The predetermined analysis method may, for example, be the analysis method provided in the publication by Simon, D. L. and Litt, J. S., cited in the related art. The quasi-steady-state time intervals of the operating period may describe those time intervals in which the turbomachine may be in a quasi-steady-state operating state. Such a quasi-steady-state operating state is identified by the ascertained measured operating values of the particular operating parameters. The analysis device may generate quasi-steady-state operating data points for the quasi-steady-state time intervals in a subsequent step, according to a predetermined averaging method. The quasi-steady-state operating data points include averaged measured operating values of the measured operating values of the particular operating parameters detected during the particular quasi-steady-state time intervals. In other words, it is provided that particular quasi-steady-state operating data points are generated for the particular quasi-steady-state time intervals, the measured operating values of the particular operating parameters being averaged measured operating values that have been generated from the measured operating values detected during the quasi-steady-state time interval. The method of Simon, D. L. and Litt, J. S., cited in the indicated related art, may be used as the predetermined averaging method for generating the quasi-steady-state operating data points.

In the described procedure, it is advantageous that a plurality of quasi-steady-state operating data points may be generated. For the operating data points identified during a flight, due to the approximately constant operating conditions, less scattering is to be expected than with a comparison of the operating data points of multiple flights.

It is provided that the analysis device ascertains particular expected data points for the quasi-steady-state operating data points according to a predetermined expected value ascertainment method. The expected data points include particular expected operating values of the particular operating parameters. The expected data points may be generated with the aid of simulations or based on models of the turbomachine, it being possible for the expected operating values to describe expected measured operating values of the particular operating parameters. The analysis device may ascertain particular measured operating value residuals of the particular operating parameters which describe the deviations between the expected operating values and the averaged measured operating values of the particular operating parameters. The method step may, for example, likewise be taken from the publication by Simon, D. L. and Litt, J. S.

In a further step, the measured operating value residuals of the particular quasi-steady-state operating data points are checked for compliance with predetermined criteria with regard to predefined nominal values of the measured operating value residuals. In other words, the particular measured operating value residuals, which describe the deviation between the expected operating values and the averaged measured operating values of the particular operating parameters, are compared to predefined nominal values of the measured operating value residuals. The nominal values of the measured operating value residuals may, for example, be measured operating value residuals that may have been ascertained based on previous detected operating value residuals. The predetermined criteria may include predefined value templates which may describe permissible value ranges of the particular measured operating value residuals. It is provided that an anomaly indicator is generated by the analysis device and transferred to a machine monitoring device. The anomaly indicator includes the violated criterion and a point in time that the particular criterion was violated.

The method results in the advantage that continuous measured operating values may be processed for use in known machine monitoring methods. It is thus possible to carry out long-term monitoring of turbomachines based on averaged measured operating values that have lower noise behavior. By monitoring the compliance of the predetermined criteria with regard to predefined nominal values of the measured operating value residuals, it is also possible to detect, in real time, deviations that occur spontaneously or for a short period, which are not detectable, or are detectable only with a certain latency, in machine monitoring methods according to the current related art.

The present invention also encompasses refinements which result in further advantages.

One refinement of the present invention provides that the method includes a step of ascertaining the predetermined nominal values of the measured operating value residuals according to a predetermined standard ascertainment method, based on measured operating value residuals of quasi-steady-state operating data points of previous operating periods of the turbomachine that are stored in the analysis device. In other words, it is provided that the predetermined nominal values of the measured operating value residuals, which are used to recognize an anomaly, are based on measured operating value residuals that are stored in the analysis device and that have been ascertained for quasi-steady-state operating data points of previous operating periods. The refinement results in the advantage that the nominal values are specifically matched to the behavior of the particular turbomachine.

One refinement of the present invention provides that the particular quasi-steady-state operating data points are added to a time series. In other words, it is provided that the time series including the particular quasi-steady-state operating data points is generated in the analysis device, or the quasi-steady-state operating data points of the operating period are added to a time series that includes quasi-steady-state operating data points of previous operating periods of the turbomachine. The refinement of the present invention results in the advantage that a long-term behavior of the turbomachine over multiple operating periods of the turbomachine may be ascertained based on the detected quasi-steady-state data points.

One refinement of the present invention provides that for the particular quasi-steady-state operating data points, the analysis device ascertains particular quality parameters, and only those quasi-steady-state operating data points whose quality parameters meet a predetermined quality criterion are added to a time series. In other words, it is provided that the particular quasi-steady-state operating data points are assessed by the analysis device. The assessment takes place by ascertaining the particular quality parameter for the particular quasi-steady-state data points, according to a predetermined method. The quality parameter may, for example, include a variance of the averaged measured operating values. By use of the analysis device, only those quasi-steady-state operating data points that include a particular quality parameter that meets the predetermined quality criterion are added to the time series. The quasi-steady-state operating data points whose particular quality parameter does not meet the predetermined quality criterion are not added to the time series. The predetermined quality criterion may specify, for example, that only those quasi-steady-state operating data points whose measured operating values do not exceed a predetermined variance are added to the time series. The refinement makes it possible to identify those quasi-steady-state operating data points that are particularly representative of a quasi-steady-state behavior. The refinement results in the advantage that the time series is based only on steady-state operating data points that are particularly representative.

One refinement of the present invention provides that the time series is transferred to the machine monitoring device by the analysis device. In other words, it is provided that the generated time series is transferred to the machine monitoring device for the evaluation. The refinement of the present invention results in the advantage that the time series may be evaluated by the machine monitoring device in order to ascertain long-term tendencies.

One refinement of the present invention provides that the machine monitoring device ascertains the quasi-steady-state operating data point in whose quasi-steady-state time interval the point in time of the anomaly indicator falls, and the anomaly indicator is assigned at least to this quasi-steady-state operating data point. In other words, it is provided that the machine monitoring device ascertains in which quasi-steady-state time interval the point in time, which is described in the anomaly indicator, falls. The anomaly indicator is subsequently assigned at least to the quasi-steady-state operating data point in whose quasi-steady-state time interval the anomaly indicator lies.

One refinement of the present invention provides that the machine monitoring device assigns the anomaly indicator at least to the quasi-steady-state operating data points whose time intervals lie after the point in time. In other words, it is provided that the anomaly indicator is assigned to the quasi-steady-state operating data points whose time intervals lie after the point in time that is indicated in the anomaly indicator.

One refinement of the present invention provides that the machine monitoring device examines, according to a predetermined error diagnosis method, at least the quasi-steady-state operating data points of the time series to which the anomaly indicator is assigned. In other words, at least the quasi-steady-state operating data points that include the anomaly indicator are checked by the machine monitoring device according to a predetermined error diagnosis method. The error diagnosis method may be the error diagnosis method that is customary for known machine monitoring devices according to the related art. The refinement results in the advantage that those operating data points that describe a point in time of an occurrence of an error or that have been detected after an occurrence of an error are explicitly examined.

A second aspect of the present invention relates to an analysis device, the analysis device being configured to ascertain, according to a predetermined analysis method, quasi-steady-state time intervals of an operating period that meet a predetermined quasi-steady-state criterion. The analysis device is configured to generate quasi-steady-state operating data points for the quasi-steady-state time intervals according to a predetermined averaging method, the quasi-steady-state operating data points including averaged measured operating values of the operating values of the particular operating parameters detected during the particular quasi-steady-state time intervals. The analysis device is configured to ascertain, according to a predetermined expected value ascertainment method, particular expected data points for the quasi-steady-state operating data points which include particular expected operating values of the particular operating parameters. The analysis device is configured to ascertain particular measured operating value residuals of the particular operating parameters that describe the deviations between the expected operating values and the averaged measured operating values of the particular operating parameters, and to check measured operating value residuals of the particular quasi-steady-state operating data points for compliance with predetermined criteria with regard to predefined nominal values of the measured operating value residuals. If a violation of at least one of the predetermined criteria is detected, the analysis device is configured to transfer an anomaly indicator, which includes the violated criterion and a point in time of the violation, to a machine monitoring device.

Further features and their advantages are apparent from the descriptions of the first aspect of the present invention.

A third aspect of the present invention relates to a machine monitoring device, the machine monitoring device being configured to receive a time series including quasi-steady-state operating data points for a particular quasi-steady-state time interval of an operating period, the quasi-steady-state operating data points including averaged measured operating values of measured operating values of particular operating parameters that are detected during the particular quasi-steady-state time intervals. The machine monitoring device is configured to receive an anomaly indicator that includes a violated criterion and a point in time of the violation. The machine monitoring device is configured to ascertain the quasi-steady-state operating data point in whose quasi-steady-state time interval the point in time of the anomaly indicator falls, and to assign the anomaly indicator at least to this quasi-steady-state operating data point. The machine monitoring device is configured to examine, according to a predetermined error diagnosis method, at least the quasi-steady-state operating data points of the time series to which the anomaly indicator is assigned.

Further features and their advantages are apparent from the descriptions of the first and second aspects of the present invention.

The analysis device and the machine monitoring device may contain one or multiple computers, one or multiple microcontrollers, and/or one or multiple integrated circuits, for example one or multiple application-specific integrated circuits (ASICs), one or multiple field-programmable gate arrays (FPGAs), and/or one or multiple systems on a chip (SoCs). The processing unit may also contain one or multiple processors, for example one or multiple microprocessors, one or multiple central processing units (CPUs), one or multiple graphics processing units (GPUs), and/or one or multiple signal processors, in particular one or multiple digital signal processors (DSPs). The processing unit may also involve a physical or virtual combination of computers or of the other stated units.

### BRIEF DESCRIPTION OF THE DRAWINGS

Further features of the present invention result from the claims, the figures, and the description of the figures. The features and feature combinations mentioned above in the description as well as the features and feature combinations mentioned below in the description of the figures and/or only shown in the figures may be used not only in the particular stated combination, but also in other combinations without departing from the scope of the present invention. Thus, embodiments not explicitly shown or explained in the figures, but which follow and are producible from the described embodiments via separate feature combinations, are thus regarded as encompassed and disclosed by the invention. In addition, embodiments and feature combinations which thus do not include all features of an originally formulated independent claim are regarded as disclosed. Furthermore, embodiments and feature combinations, in particular resulting from the embodiments discussed above, which go beyond or deviate from the feature combinations described in the back-references of the claims are regarded as disclosed. In the figures:

FIG. 1 shows a schematic illustration of a sequence of a method for recognizing an anomaly in measured operating values of a turbomachine;

FIG. 2 shows a schematic illustration of one possible time series that includes quasi-steady-state data points;

FIG. 3 shows a schematic illustration of a sequence of the method steps of the method for detecting the quasi-steady-state time periods and generating the quasi-steady-state data points; and

FIG. 4 shows a schematic illustration of a sequence of the method steps of the method for detecting the anomalies.

### DETAILED DESCRIPTION

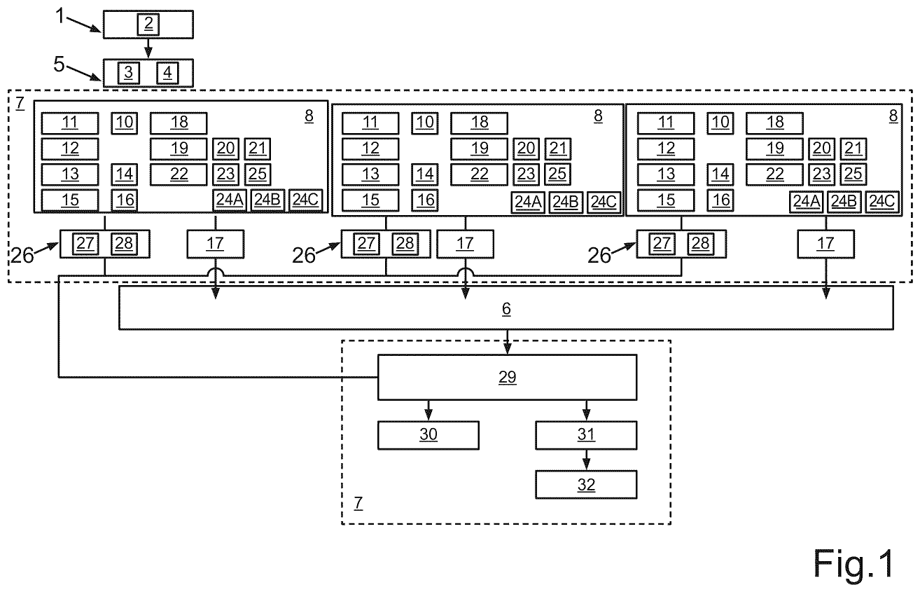

FIG. 1 shows a schematic illustration of a sequence of a method for recognizing an anomaly in measured operating values of a turbomachine. A turbomachine 1, which may be a turbomachine 1 of an aircraft, for example, may be operated over an operating period, it being possible for sensors 2 of turbomachine 1 to repeatedly detect measured operating values 3 of turbomachine 1 during operation of turbomachine 1. Sensors 2 may detect measured operating values 3 at predetermined time intervals or continuously during the operating period. Measured operating values 3 may be associated with particular operating parameters 4. Operating parameters 4 may include, for example, a rotational speed of turbomachine 1 and/or a temperature of turbomachine 1. Detected measured operating values 3 may be added to a measured operating value time series 5, which may be associated with the particular operating period of turbomachine 1. Measured operating value time series 5 may be limited to a certain flight, for example. Measured operating value time series 5 may describe, for example, how measured operating values 3 of operating parameters 4 change over the operating period. By detecting measured operating values 3 during the operating period, it may be possible to recognize, for example, malfunctions of turbomachine 1.

To allow detection of trends of turbomachine 1 that indicate damage or wear, it is customary to record measured operating values 3 during multiple operating periods of turbomachine 1. Certain data points that describe measured operating values 3 of operating parameters 4 at a particular point in time are ascertained and added to a time series 6, which may be evaluated by a machine monitoring device 9. For each operating period, it is customary to provide one or two of the data points and add them to time series 6. Via an analysis of time series 6 by machine monitoring device 9, long-term trends that extend over multiple operating periods of turbomachine 1 may be identified, as well as changes in the operating behavior which arise within a very short time, possibly even suddenly. The disadvantage is that multiple operating periods may be necessary for these changes in the operating behavior to be detectable. As a result of only individual data points being provided, they have a relatively high noise level. Thus, it may not always be clearly understandable whether a single deviation of individual measured operating values 3 is to be attributed to noise or to a malfunction. Due to this lack of differentiability between noise and a malfunction, according to the related art errors are often detected from multiple flights only with a certain latency.

To allow the deviations in individual data points to be reduced and spontaneous errors to be recognized, it is provided that measured operating values 3 detected over the operating period are evaluated by an analysis device 7 in a predetermined analysis method 8. In predetermined analysis method 8, measured operating values 3 are examined for whether they meet a quasi-steady-state criterion 24A that identifies a quasi-steady-state operating state of turbomachine 1. Contiguous time intervals in which predetermined quasi-steady-state criterion 24A for quasi-steady-state time intervals is met may be identified as quasi-steady-state time intervals 10 by use of an identification method 11.

To allow generation of data points for evaluation by machine monitoring device 9, it is provided that analysis device 7 reads out, according to a predetermined readout method 12, measured operating values 3 of quasi-steady-state time intervals 10 that are detected in identification method 11. Measured operating values 3 of particular operating parameters 4 that are detected during particular quasi-steady-state time intervals 10 may be averaged according to a predetermined averaging method 13 to form averaged measured operating values 14, and averaged measured operating values 14 may be combined into a quasi-steady-state data point 17. Compared to the data points used in the related art, quasi-steady-state data points 17 have the advantage that many more may be generated, thus providing a statistically relevant database for the subsequent processing steps. It may be provided that particular quality parameters 16 of quasi-steady-state data points 17 are ascertained for particular quasi-steady-state data points 17 in a predetermined quality ascertainment method 15. Quality parameters 16 may describe, for example, the particular variance of measured operating values 3 that have been detected during particular quasi-steady-state time interval 10. Those quasi-steady-state data points 17 that meet a predetermined quality criterion 24C for quasi-steady-state time intervals may be identified as representative quasi-steady-state data points 17 and added to time series 6 by analysis device 7. It may also be provided that all of quasi-steady-state data points 17 are added to time series 6. Providing quasi-steady-state data points 17 in time series 6 allows machine monitoring device 9 to detect long-term trends and/or damage in turbomachine 1. To allow detection of short-term changes or spontaneously occurring errors during operation of turbomachine 1, it may be provided that analysis device 7 checks quasi-steady-state data points 17 for an occurrence of anomalies, using a predetermined detection method 18. In detection method 18 it may be provided that particular expected data points 20 for particular quasi-steady-state data points 17 are ascertained in a first step according to a predetermined expected value ascertainment method 19. Expected data points 20 may include expected operating values 21 that may be assigned to particular operating parameters 4. Expected operating values 21 may describe measured operating values 3 that may describe an intended operation of turbomachine 1. These may be ascertained with the aid of a model or a simulation of turbomachine 1, for example. In one measured operating value residual ascertainment method 22, it may be provided that measured operating value residuals 23 may be ascertained between measured operating values 3 of particular operating parameters 4 and expected operating values 21 of particular operating parameters 4. These may describe the extent of deviation of measured operating values 3 from expected operating values 21. To allow a determination of whether measured operating value residuals 23 are in a normal range or indicate an anomaly of the behavior of turbomachine 1, it may be provided that measured operating value residuals 23 of particular quasi-steady-state data points are checked for compliance with predetermined anomaly criteria 24B for the anomaly detection with regard to predefined nominal values 25 of measured operating value residuals 23.

An anomaly may be recognized, for example, by at least one or multiple of predetermined anomaly criteria 24B being violated. Anomaly criteria 24B may specify, for example, permissible value ranges of measured operating values 3 or permissible relationships between measured operating values 3 of different operating parameters 4, or may concern compliance with a limiting value with regard to a number of outliers. For the case that the anomaly is detected, it may be provided that an anomaly indicator 26 is generated which includes violated anomaly criterion 27 of predetermined anomaly criteria 24B and a point in time 28 of the violation. This anomaly indicator 26 may be transferred to machine monitoring device 9 by analysis device 7. Machine monitoring device 9 may be provided to carry out a predetermined monitoring method 29, also referred to as trend monitoring. Errors in the operation of turbomachine 1 may thus be detected. Monitoring method 29 may include, for example, so-called long-term trending 30, which may be provided to detect long-term deteriorating conditions of turbomachine 1 by monitoring of measured operating values 3. Machine monitoring device 9 may be configured to supply quasi-steady-state data points 17, which may be assigned to anomaly indicator 26, to an error identification method 31 for identifying an error caused by the anomaly, and to optionally supply quasi-steady-state data points 17 to a quantification method 32 in order to ascertain an extent of the error.

In other words, FIG. 1 shows one possible integration of the continuously

recorded flight data into existing engine trend monitoring (ETM) applications for carrying out engine trend monitoring methods in machine monitoring device 9. The continuous data of the individual flights are processed by an analysis method 8 in the first step. Analysis method 8 is made up of a data filter for identifying quasi-steady-state data points 17, and a detection method 18 for detecting individual occurrences of damage. In the search for quasi-steady-state data points 17, it is generally to be assumed that a plurality of such quasi-steady-state flight segments for each flight may be found. However, due to the slow development of damage with gradual wear, a large quantity of data points does not provide a direct gain of information with regard to long-term trending 30. For this reason, a limitation is made to a few particularly stable quasi-steady-state data points 17. These particularly stable quasi-steady-state time intervals 10 may subsequently be combined to form a new time series 6. This corresponds to plotting a few data points for each flight cycle, and thus corresponds to the current related art. Similarly, this time series 6 may be relayed directly to existing ETM systems and processed by them. Within detection method 18, the continuous flight data may be additionally examined for possibly present anomalies within the data set of measured operating values 3. If anomalies are found, a corresponding damage indication in the form of an anomaly indicator 26, also referred to as anomaly flags, may be set and transferred to the existing ETM system for subsequent further processing. As a result, there is an additional error indication via which possibly necessary further steps, made up of error identification and error quantification, may be directly initiated without latency. For the error identification and error quantification, recourse may initially be made to existing algorithms based on individual snapshots.

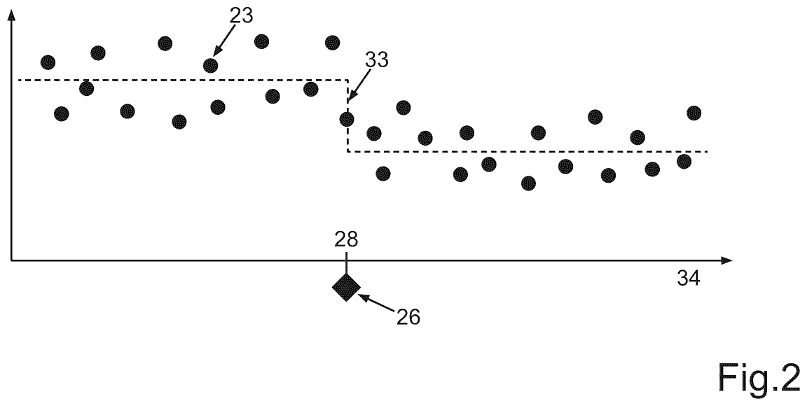

FIG. 2 shows a schematic illustration of one possible time series 6 that includes quasi-steady-state data points 17 (see, e.g., FIG. 1). A parameter profile 33 over a time period 34 that may extend over multiple operating periods 34 is illustrated. The figure shows individual values of measured operating value residuals 23 of a certain operating parameter 4 over time period 34. A point in time 28 may be designated by anomaly indicator 26. Anomaly indicator 26 may be assigned, for example, to measured operating value residual 23 that is associated with quasi-steady-state data point 17, whose time interval 10 includes point in time 28 at which the anomaly is detected. Within the scope of the trend monitoring, an analysis of the data may take place based on measured operating value residuals 23 between averaged measured operating values 14 of ascertained quasi-steady-state data points 17 and expected operating values 21 from simulations or a model of turbomachine 1. Measured operating value residuals 23 of the individual flights form a time series 6 over the flight cycles. Due to measurement and model uncertainties, individual measured operating value residuals 23 are subject to scattering around an unknown, underlying true parameter profile 33. A single error manifests as a sudden change within this true parameter profile 33. Depending on the severity of the error, according to the current related art multiple flights are necessary for a reliable differentiation between an error and measurement noise. With the aid of the provided method, anomaly flags 26 that are obtained from the continuous data of measured operating value time series 5 may be additionally utilized and indicated within the trend monitoring.

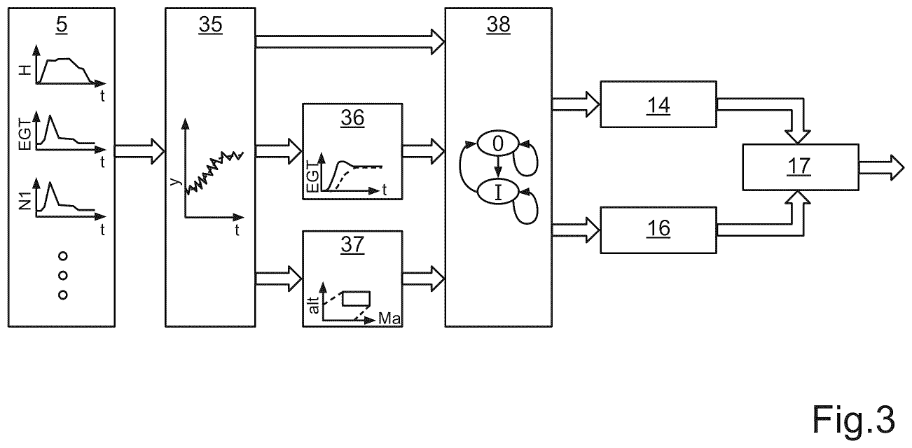

FIG. 3 shows a schematic illustration of a sequence of the method steps of analysis method 8 for detecting quasi-steady-state time intervals 10 and generating quasi-steady-state data points 17. The basic mode of operation of an identification method 11 of analysis method 8 designed as a steady state detector is based on a publication by Simon, D. L. & Litt, J. S. The original method was derived for identifying quasi-steady-state data points 17 for helicopter engines, and has been adapted for the present application for turbine aircraft engines. The steady state detector is a method made up of multiple modules, and is illustrated in FIG. 3. The measurement uncertainty within the data may adversely affect the number of identified quasi-steady-state data points 17. The variance within measured operating value time series 5 may be reduced, and the consistency of detected steady-state data increased, by using a low pass filter 35. A second-order filter is recommended as a low pass filter:

$$\frac{\tilde{y} ( s )}{y ( s )} = \frac{{ω}_{n}^{2}}{{s}^{2} + 2 ζ {ω}_{n} s + {ω}_{n}^{2}}$$

For ascertaining quasi-steady-state operating points, it must be ensured that all engine components are in an approximately thermally balanced state. However, due to the lack of measured operating values 3 with regard to the material temperatures within the engine, it is not possible to directly monitor the thermal state of the engine. Within thermal transient filter 36 the thermal behavior of the engine is described by a substitute model. The thermal behavior of the engine components may generally be modeled via a first-order delay element. In this case the material temperature may be approximated by filtering the exhaust gas temperature (EGT). Further details may be obtained from Joachim Kurzke and Ian Halliwell, Propulsion and Power, September, Cham: Springer International Publishing, 18, pp. {39}.

$$\frac{( s )}{EGT ( s )} = \frac{1}{τ s + 1} ,$$

where [symbol] corresponds to the filtered EGT and τ describes the time constant of the filter. The time constant characterizes the thermal behavior of the individual components. Within thermal transient filter 36, it is assumed that the engine is in a thermally balanced state as soon as the temperature of the comparative mass has approached the EGT.

$$\vert - EGT \vert \leq Δ {EGT}_{max}$$

The operating range to be considered may be limited within regime recognition 37. During subsequent use, for example the generated steady-state data points may be limited to operating ranges for which the simulations or the model of the turbomachine for computing expected operating values 21 have/has been calibrated. In this way, the model uncertainty and thus the scattering within the residuals may be minimized and the number of false alarms may be reduced.

Within state transition logic 38, the pieces of information from low pass filter 35, thermal transient filter 36, and regime recognition 37 are combined and the steady-state data points are computed. For defining a stable operating range, the data are initially sampled across a moving window. A consideration of the stability of measured operating values 3 takes place when all data within the moving window are in a thermally balanced state and are within the valid operating range. The maximum variation in measured operating values 3 may be determined for measured operating values 3 that are detected across the moving window, or, for example, also via the variance of the measured operating values. Using the example of fan rotational speed N₁, the maximum variation is as follows:

$${D}_{N 1} = max ( {N}_{1} ) - min ( {N}_{1} )$$

If the maximum variations in individual measured operating values 3 are below a predefined limiting value, a stable flight state is assumed, and the data within the moving window are averaged and thus combined to form a quasi-steady-state data point 17. In addition, quality parameter 16 for individual quasi-steady-state time interval 10 may be defined for quantifying the stability of the individual data points. Since individual measured operating values 3 cannot be directly compared to one another due to the different physical units and ranges, quality parameter 16, QA may result from the sum, weighted with W, of the variances o of individual measured operating values 3 that are nondimensionalized with maximum variations Dₘₐₓ.

$$QA = {\sum }_{i = 1}^{N} W ( i ) \frac{{σ}_{i}}{{D}_{i , max}^{2}}$$

The individual stable data points may be subsequently sorted based on their quality parameter 16, and a few particularly stable quasi-steady-state time intervals 10 may be filtered out.

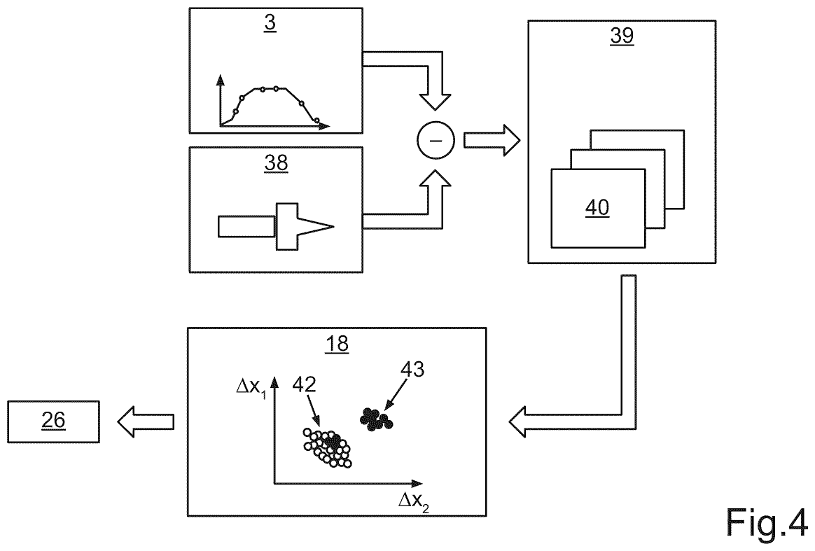

FIG. 4 shows a schematic illustration of a sequence of the method steps of the method for detecting the anomalies. FIG. 4 shows one example of a method for detecting individual occurrences of damage within continuous data sets. Within the scope of long-term trending 30, only a few particularly stable quasi-steady-state data points 17 are needed for an analysis of the gradual wear. However, each of identified quasi-steady-state data points 17 contains important information about the present condition of the engine, so that this information may be used to detect individual occurrences of damage. Therefore, a detection of anomalies within continuous measured operating values 3 that may indicate possible errors takes place based on the entirety of identified quasi-steady-state data points 17. For this purpose, for individual quasi-steady-state data points 17, analysis device 7 initially generates particular expected data points 20 for the nominal behavior of the engine via a simulation or a model of turbomachine 44, for example a performance computation program. These expected data points 20 are subsequently compared to actual quasi-steady-state data points 17, and measured operating value residuals 23 are ascertained. Measured operating value residuals 23 of multiple direct precursor flights 40 may be stored in a database 39, and within the scope of the anomaly detection may be used as nominal values 25 of measured operating value residuals 23 for the nominal behavior of the engine. Lastly, within the scope of anomaly detection 18, measured operating value residuals 42 of the present flight may be compared to the stored nominal values of measured operating value residuals 25, generated from measured operating value residuals 43 of previous flights 40, and examined for outliers from the nominal behavior. An anomaly criterion 24B for anomaly detection may relate to compliance with a limiting value with regard to the number of outliers. If the number of found outliers from the nominal behavior exceeds a specified limiting value, the initiation of an anomaly indicator 26 takes place.

Within previous engine condition monitoring applications, the detection of engine damage is based on a few discretely recorded data points. These data points are typically recorded within the high-load takeoff and climbing phases and during the steady-state cruising flight. Due to the stable ambient conditions and the steady-state operating state, the data point that is recorded during the cruising flight is particularly suited for an analysis of the engine condition over multiple flights. Thus, in the most unfavorable case, merely a single data point for each flight is effectively available for detecting damage. This often results in difficulties in differentiating between an error and statistical noise. Therefore, multiple flights are generally necessary in order to reliably detect an error. Recent engines are currently capable of providing continuous measured operating values 3. These continuous time signals allow, for the first time, the events between the discrete data points to be analyzed, and damage to be potentially detected more quickly. The continuous flight data provide advantages in particular in the detection of individual errors. A statistically relevant database for a latency-free detection of the errors may be provided by using continuously sampled data sets. In contrast, the gradual wear proceeds only very slowly, and therefore cannot be detected within a single flight. The continuous data offer no additional information content here. The engine parameters must be considered over multiple flight cycles for an analysis of the gradual wear. Existing long-term trending 30 applications based on a few steady-state data points for each flight are regarded as suitable for this purpose. For the integration of continuous flight data into existing engine condition monitoring applications, new algorithms are necessary in order to take into account the different requirements for detecting individual errors and analyzing the gradual wear. For an analysis of the gradual wear, quasi-steady-state data points 17 from particularly stable flight segments must be initially identified within the continuous measured data, and the algorithms for long-term trending 30 may be provided for the further processing. At the same time, detection methods 18 are required which are able to process the continuous data sets and examine them for deviations from nominal behavior, which indicate damage.

Only individual discretely recorded data points (so-called snapshots) are presently available for detecting engine damage. Due to the few available data points for each flight, errors generally cannot be directly distinguished from statistical noise. At the present time, detecting damage at static or rotating components within the gas path of an engine is thus generally possible only after multiple flights.

Various analysis methods for detecting anomalies based on discrete data points recorded during flight, with the disadvantage of latency in the damage detection, are known in the related art. These include various data filters for identifying quasi-steady-state data points, or methods for detecting engine damage based on continuous data. However, they have no connection with existing engine trend monitoring (ETM) systems.

The present invention relates to introduction of a holistic method for detecting errors/damage based on data of the entire flight, and integration of the method into a snapshot-based monitoring system that includes the following elements:
1) detection of quasi-steady-state flight segments within the continuous flight data
2) damage detection based on the available continuous flight data
3) localization of the damage (damage diagnosis)
4) transfer of the damage detection and diagnosis as well as representative quasi-steady-state data points to the long-term trending.

A statistically relevant database is available as a result of using the continuous data for the damage detection. Data analysis methods that allow detection of damage within a flight may thus be applied. This results in increased reliability of the damage detection by reducing false positives. In addition, due to the reduction of the continuous data to quasi-steady-state data points, existing algorithms based on the use of snapshots may be further used for the long-term trending and for detecting damage.

### LIST OF REFERENCE NUMERALS

1 turbomachine
2 sensors
3 measured operating value
4 operating parameter
5 measured operating value time series
6 time series
7 analysis device
8 analysis method
9 machine monitoring device
10 quasi-steady-state time interval
11 identification method
12 readout method
13 averaging method
14 averaged measured operating value
15 quality ascertainment method
16 quality parameter
17 quasi-steady-state data point
18 detection method
19 expected value ascertainment method
20 expected data point
21 expected operating value
22 measured operating value residual ascertainment method
23 measured operating value residual
24A criterion for quasi-steady-state time intervals
24B anomaly criterion for an anomaly detection
24C quality criterion
25 nominal value of the measured operating value residual
26 anomaly indicator
27 violated anomaly criterion
28 point in time of the violation of the criterion for an anomaly detection
29 monitoring method
30 long-term trending
31 error identification method
32 quantification method
33 parameter profile
34 time period over multiple operating periods
35 low pass filter
36 thermal transient filter
37 regime recognition
38 state transition logic
39 database
40 precursor flights
42 measured operating value residuals of a current flight
43 measured operating value residuals of previous flights
44 simulation or model of the turbomachine

What is claimed is:

1-10. (canceled)

11. A method for recognizing an anomaly in measured operating values of a turbomachine, in particular an aircraft turbine, including at least the steps:
repeatedly detecting measured operating values of particular operating parameters of a turbomachine during an operating period of the turbomachine, using sensors of the turbomachine;
ascertaining, according to a predetermined analysis method, quasi-steady-state time intervals of the operating period that meet a predetermined criterion for quasi-steady-state time intervals, using an analysis device;
generating quasi-steady-state operating data points for the quasi-steady-state time intervals according to a predetermined averaging method, the quasi-steady-state operating data points including averaged measured operating values of the measured operating values of the particular operating parameters detected during the particular quasi-steady-state time intervals;
ascertaining, according to a predetermined expected value ascertainment method, particular expected data points for the quasi-steady-state operating data points including particular expected operating values of the particular operating parameters;
ascertaining particular measured operating value residuals of the particular operating parameters describing deviations between the expected operating values and the averaged measured operating values of the particular operating parameters;
checking the measured operating value residuals of the particular quasi-steady-state operating data points for compliance with predetermined anomaly criteria for an anomaly detection with regard to predefined nominal values of the measured operating value residuals; and
transferring an anomaly indicator including a violated anomaly criterion of the anomaly criteria for an anomaly detection and a point in time of the violation, to a machine monitoring device.

12. The method as recited in claim 11 wherein the analysis device ascertains the predetermined nominal values of the measured operating value residuals according to a predetermined standard ascertainment method, based on measured operating value residuals of quasi-steady-state operating data points of previous operating periods of the turbomachine that are stored in the analysis device.

13. The method as recited in claim 11 wherein the particular quasi-steady-state operating data points are added to a time series by the analysis device.

14. The method as recited in claim 11 wherein for the particular quasi-steady-state operating data points, the analysis device ascertains particular quality parameters, and only those quasi-steady-state operating data points whose quality parameters meet a predetermined quality criterion are added to a time series.

15. The method as recited in claim 14 wherein the analysis device transfers the time series to the machine monitoring device.

16. The method as recited in claim 15 wherein the machine monitoring device ascertains the quasi-steady-state operating data point in whose quasi-steady-state time interval the point in time of the anomaly indicator falls, and the anomaly indicator is assigned at least to this quasi-steady-state operating data point.

17. The method as recited in claim 15 wherein the machine monitoring device assigns the anomaly indicator at least to the quasi-steady-state operating data points whose time intervals lie after the point in time.

18. The method as recited in claim 15 wherein the machine monitoring device examines, according to a predetermined error diagnosis method, at least the quasi-steady-state operating data points of the time series to which the anomaly indicator is assigned.

19. A method for providing maintenance using the method as recited in claim 15, the method comprising provided maintenance to the turbomachine based on the anomaly.

20. An analysis device, the analysis device being configured to
ascertain, according to a predetermined analysis method, quasi-steady-state time intervals of an operating period that meet a predetermined criterion for quasi-steady-state time intervals,
generate quasi-steady-state operating data points for the quasi-steady-state time intervals according to a predetermined averaging method, the quasi-steady-state operating data points including averaged measured operating values of the operating values of the particular operating parameters detected during the particular quasi-steady-state time intervals;
ascertain particular expected data points for the quasi-steady-state operating data points according to a predetermined expected value ascertainment method, the expected data points including particular expected operating values of the particular operating parameters;
ascertain particular measured operating value residuals of the particular operating parameters describing deviations between the expected operating values and the averaged measured operating values of the particular operating parameters;
check measured operating value residuals of the particular quasi-steady-state operating data points for compliance with predetermined anomaly criteria with regard to predefined nominal values of the measured operating value residuals; and
transfer an anomaly indicator including the violated anomaly criterion of the anomaly criteria and a point in time of the violation, to a machine monitoring device.

21. A machine monitoring device configured to
receive a time series including quasi-steady-state operating data points for particular quasi-steady-state time intervals of an operating period, the quasi-steady-state operating data points including averaged measured operating values of measured operating values of particular operating parameters detected during the particular quasi-steady-state time intervals;
receive an anomaly indicator including a violated anomaly criterion and a point in time of the violation;
ascertain the quasi-steady-state operating data point in whose quasi-steady-state time interval the point in time of the anomaly indicator falls, and to assign the anomaly indicator at least to this quasi-steady-state operating data point; and
examine, according to a predetermined error diagnosis method, at least the quasi-steady-state operating data points of the time series to which the anomaly indicator is assigned.
